(19) United States
(12) Patent Application Publication
(10) Pub. No.: US 2026/0023172 A1
(43) Pub. Date: Jan. 22, 2026

(54) SYSTEM AND METHOD FOR SECURE TRACKING AND ELIGIBILITY IDENTIFICATION OF OBJECTS IN SECURE STORAGE CONTAINERS

(71) Applicant: BANK OF AMERICA CORPORATION, Charlotte, NC (US)

(72) Inventors: Saurabh Arora, Gurugram (IN); Sandeep Kumar Chauhan, Hyderabad (IN); Prakash Thatipamula, Hyderabad (IN)

(73) Assignee: BANK OF AMERICA CORPORATION, Charlotte, NC (US)

(21) Appl. No.: 18/779,737

(22) Filed: Jul. 22, 2024

(51) Int. Cl. G01S 13/06; G08B 21/18

(52) U.S. Cl. CPC G01S 13/06; G08B 21/18

(57) ABSTRACT

Embodiments of the present invention provide a system for secure tracking and eligibility identification of objects in secure storage containers. In particular, the system may be configured to cause a radar device to perform one or more actions on one or more objects placed in a secure storage container, receive raw data associated with the one or more actions from the radar device, apply transformations to raw data to generate transformed data, process the transformed data to classify materials associated with the one or more objects in the secure storage container, determine eligibility of the materials associated with the one or more objects in the secure storage container based on classification of the materials associated with the one or more objects, and continuously track the one or more objects in the secure storage container based on performing the one or more actions.

### BACKGROUND

There exists a need for a system for secure tracking and eligibility identification of objects in secure storage containers.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for secure tracking and eligibility identification of objects in secure storage containers. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention causes a radar device to perform one or more actions on one or more objects placed in a secure storage container comprising (i) transmitting electromagnetic waves onto the one or more objects, in response to transmitting the electromagnetic waves onto the one or more objects, (ii) receiving reflected waves back from the one or more objects, and (iii) transmitting raw data associated with the reflected waves to the system, receives the raw data associated with the reflected waves from the radar device, applies transformations to raw data to generate transformed data, processes the transformed data to classify materials associated with the one or more objects in the secure storage container, and determines eligibility of the materials associated with the one or more objects in the secure storage container based on classification of the materials associated with the one or more objects.

In some embodiments, the present invention determines that at least one object of the one or more objects is not eligible for storage in the secure storage container and transmits one or more alerts to a user associated with the secure storage container and an entity user associated with an entity managing the secure storage container.

In some embodiments, the present invention causes the radar device to perform the one or more actions at predefined time intervals, receives periodic raw data from the radar device based on performing the one or more actions at the predefined time intervals, and generates one or more patterns associated with the one or more objects placed in the secure storage container based on the periodic raw data.

In some embodiments, the present invention detects a deviation in the one or more patterns, determines a type of deviation in the one or more patterns, and determines at least one of displacement of the one or more objects and replacement of the one or more objects in the secure storage container based on the type of deviation.

In some embodiments, the present invention in response to determining at least one of the displacement of the one or more objects and the replacement of the one or more objects in the secure storage container, transmit one or more alerts to a user associated with the secure storage container and an entity user associated with an entity managing the secure storage container.

In some embodiments, the present invention causes the radar device to perform the one or more actions continuously, receives continuous raw data from the radar device based on performing the one or more actions at the predefined time intervals, generates one or more patterns associated with the one or more objects placed in the secure storage container based on the continuous raw data, and continuously monitors the one or more patterns for deviation.

In some embodiments, the present invention receives an input associated with tracking of the one or more objects placed in the secure storage container form a user associated with the secure storage container, causes the radar device to perform the one or more actions based on receiving the input, receives on-demand raw data from the radar device, processes the on-demand raw data and provide an output to the user associated with the tracking of the one or more objects in the secure storage container.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for secure tracking and eligibility identification of objects in secure storage containers, in accordance with an embodiment of the invention;

FIG. 2 provides a block diagram illustrating the entity system 200 of FIG. 1, in accordance with an embodiment of the invention;

FIG. 3 provides a block diagram illustrating a secure object tracking and identification system 300 of FIG. 1, in accordance with an embodiment of the invention;

FIG. 4 provides a block diagram illustrating the computing device system 400 of FIG. 1, in accordance with an embodiment of the invention;

FIG. 5 provides a block diagram illustrating one or more components of a secure storage container of FIG. 1, in accordance with an embodiment of the invention;

FIG. 6A provides a process flow for eligibility identification of objects in secure storage containers, in accordance with an embodiment of the invention; and

FIG. 6B provides a process flow for secure tracking of objects in secure storage containers, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “resource entity” or “entity” may be any institution that provides secure storage containers (e.g., safety deposit boxes) to one or more users for storing one or more objects. In some embodiments, the entity may be a financial institution. In some embodiments, the entity may be a non-financial institution.

As described herein, a “user” may be a customer or a potential customer of the entity. In some embodiments, the user may be a customer renting, leasing, and/or the like secure storage containers (e.g., safety deposit boxes) provided by the entity. In some embodiments, where the entity is a financial institution, the “user” may also be a financial institution customer (e.g., an account holder or a person who has an account (e.g., banking account, credit account, or the like)). An “account” or “resource pool” may be the relationship that the customer has with the financial institution. Examples of accounts include a deposit account, such as a transactional account (e.g. a banking account), a savings account, an investment account, a money market account, a time deposit, a demand deposit, a pre-paid account, a credit account, a non-monetary customer information that includes only personal information associated with the customer, or the like. The account is associated with and/or maintained by a financial institution.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Entities that provide secure storage containers to users have no way of determining eligibility of objects that are placed in the secure storage containers by users. Furthermore, current systems do not allow users and the entities to track the objects securely without storing details of the objects. As such, there exists a need for a system that performs secure tracking and eligibility identification of objects placed in secure storage containers.

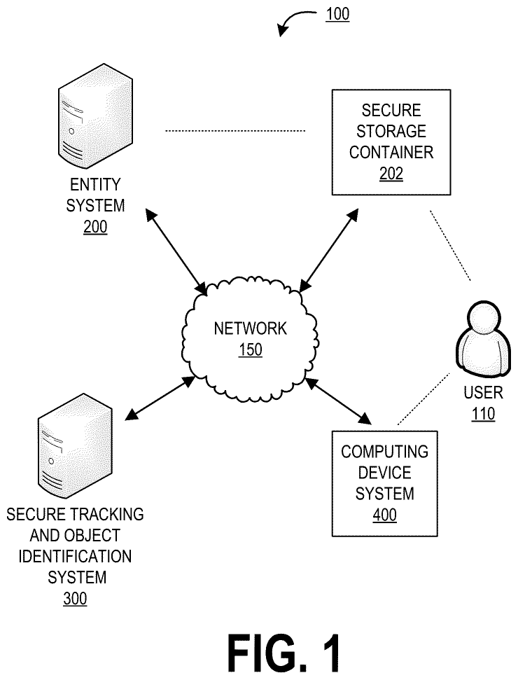

FIG. 1 provides a block diagram illustrating a system environment 100 for secure tracking and eligibility identification of objects in secure storage containers, in accordance with an embodiment of the invention. As illustrated in FIG. 1, the environment 100 includes a secure object tracking and identification system 300, entity system 200, secure storage containers 202, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers, potential customers, and/or the like of an entity associated with the entity system 200.

The entity system(s) 200 may be any system owned or otherwise controlled by an entity to support or perform one or more process steps described herein. In some embodiments, the entity may be a financial institution. In some such embodiments, the entity maintains and/or manages at least one of secure storage containers 202 and/or one or more resource pools (e.g., checking account, savings account, or the like) associated with the users 110. In some embodiments, the entity may be a non-financial institution which provides the secure storage containers 202.

The secure object tracking and identification system 300 is a system of the present invention for performing one or more process steps described herein. In some embodiments, the secure object tracking and identification system 300 may be an independent system. In some embodiments, the secure object tracking and identification system 300 may be a part of the entity system 200.

The secure object tracking and identification system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the secure object tracking and identification system 300 is configured to communicate information or instructions with the entity system 200, the secure storage container 202, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the secure object tracking and identification system 300, and/or entity system 200 across the network 150. In some embodiments of the invention, the computing device system 400 may be a mobile device.

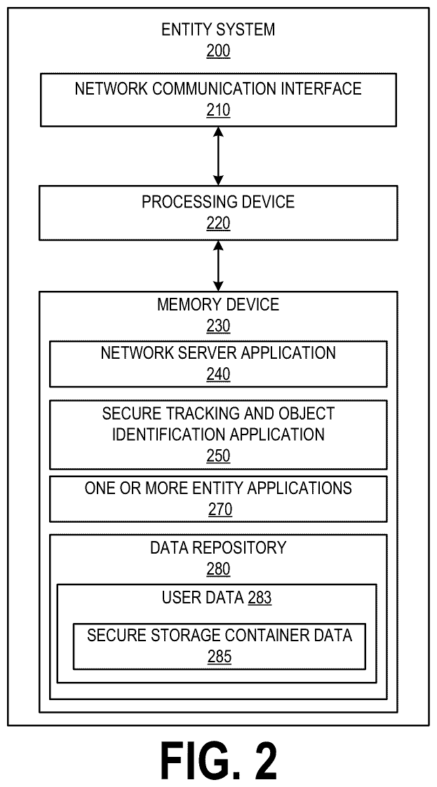

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a secure object tracking and identification application 250, one or more entity applications 270, and a data repository 280 comprising user data 283, where the user data 283 comprises data associated with users 110 and/or one or more resource pools and/or secure storage containers 202 associated with the users 110. The user data 283 further comprise secure storage container data 285 associated with the users of the corresponding user data 283. The one or more entity applications 270 may be any applications provided by the entity that allows users 110 to access information and/or perform one or more actions associated with one or more resource pools and/or the secure storage containers 202 associated with the users 110. The computer-executable program code of the network server application 240, the secure object tracking and identification application 250, the one or more entity application 270 to perform certain logic, data-extraction, and data-storing functions of the entity system 200 described herein, as well as communication functions of the entity system 200.

The network server application 240, the secure object tracking and identification application 250, and the one or more entity applications 270 are configured to store data in the data repository 280 or to use the data stored in the data repository 280 when communicating through the network communication interface 210 with the secure object tracking and identification system 300, and/or the computing device system 400 to perform one or more process steps described herein. In some embodiments, the entity system 200 may receive instructions from the secure object tracking and identification system 300 via the secure object tracking and identification application 250 to perform certain operations. The secure object tracking and identification application 250 may be provided by the secure object tracking and identification system 300.

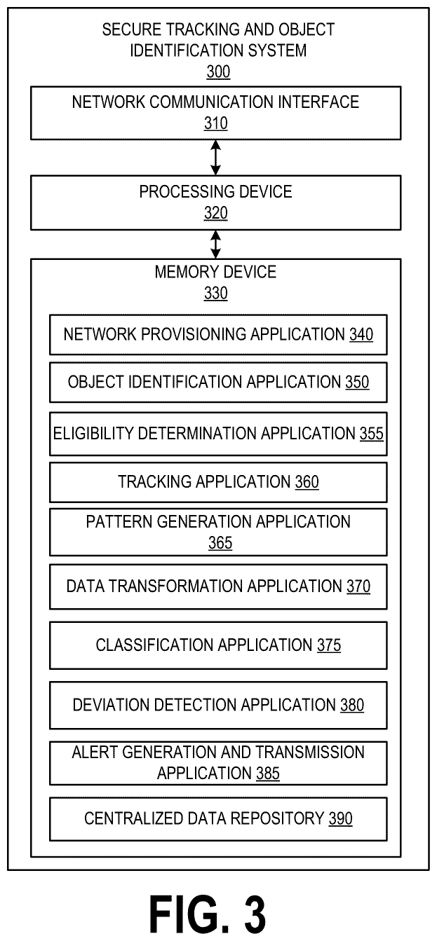

FIG. 3 provides a block diagram illustrating the secure object tracking and identification system 300 in greater detail, in accordance with embodiments of the invention. As illustrated in FIG. 3, in one embodiment of the invention, the secure object tracking and identification system 300 includes one or more processing devices 320 operatively coupled to a network communication interface 310 and a memory device 330. In certain embodiments, the secure object tracking and identification system 300 is operated by a first entity, such as a financial institution, while in other embodiments, the secure object tracking and identification system 300 is operated by an entity other than a financial institution. In some embodiments, the secure object tracking and identification system 300 is owned or operated by the entity of the entity system 200. In some embodiments, the secure object tracking and identification system 300 may be an independent system. In alternate embodiments, the secure object tracking and identification system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the secure object tracking and identification system 300 described herein. For example, in one embodiment of the secure object tracking and identification system 300, the memory device 330 includes, but is not limited to, a network provisioning application 340, an object identification application 350, an eligibility determination application 355, a tracking application 360, a pattern generation application 365, a data processing application 370, a classification application 375, a deviation detection application 380, an alert generation and transmission application 385, and a centralized data repository 390 comprising data processed or accessed by one or more applications in the memory device 330. The computer-executable program code of the network provisioning application 340, the object identification application 350, the eligibility determination application 355, the tracking application 360, the pattern generation application 365, the data processing application 370, the classification application 375, the deviation detection application 380, and the alert generation and transmission application 385 may instruct the processing device 320 to perform certain logic, data-processing, and data-storing functions of the secure object tracking and identification system 300 described herein, as well as communication functions of the secure object tracking and identification system 300.

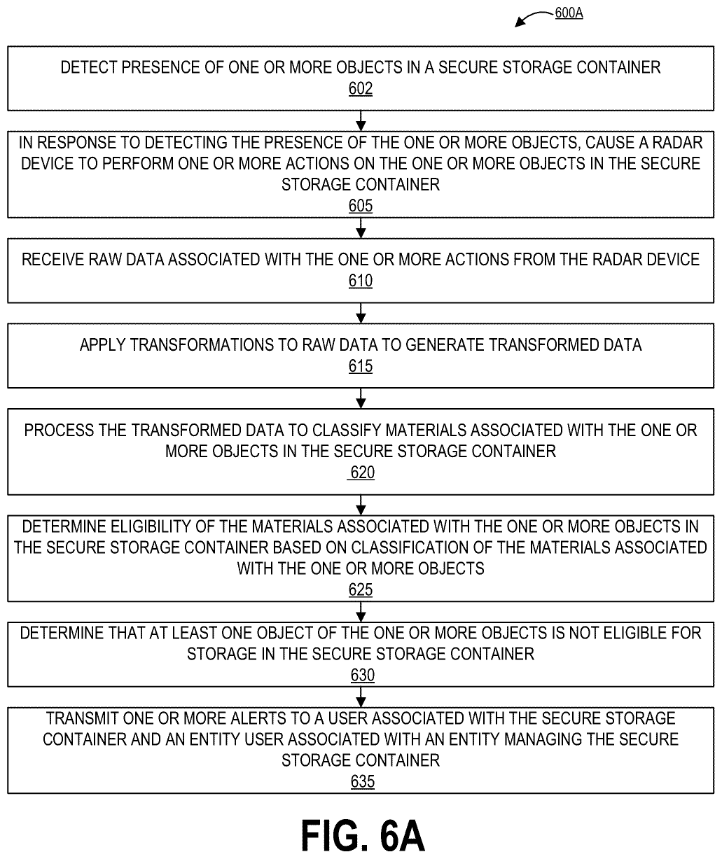

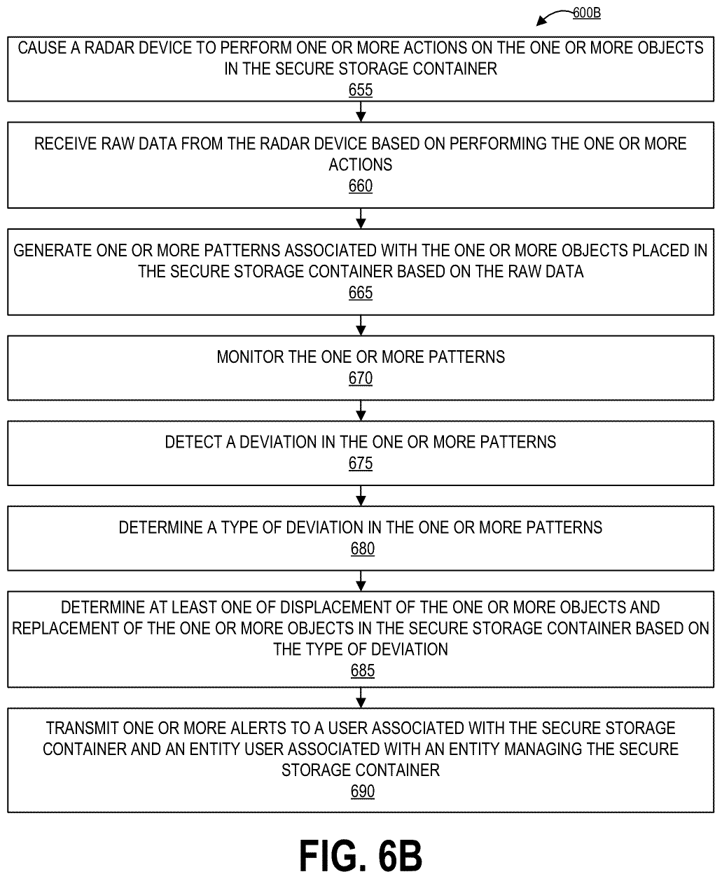

The network provisioning application 340, the object identification application 350, the eligibility determination application 355, the tracking application 360, the pattern generation application 365, the data processing application 370, the classification application 375, the deviation detection application 380, and the alert generation and transmission application 385 are configured to invoke or use the data in the data repository 390 when communicating through the network communication interface 310 with the entity system 200, and/or the computing device system 400. In some embodiments, the network provisioning application 340, the object identification application 350, the eligibility determination application 355, the tracking application 360, the pattern generation application 365, the data processing application 370, the classification application 375, the deviation detection application 380, and the alert generation and transmission application 385 may store the data extracted or received from the entity system 200, and the computing device system 400 in the centralized data repository 390. In some embodiments, the network provisioning application 340, the object identification application 350, the eligibility determination application 355, the tracking application 360, the pattern generation application 365, the data processing application 370, the classification application 375, the deviation detection application 380, and the alert generation and transmission application 385 may be a part of a single application. The functionalities of the network provisioning application 340, the object identification application 350, the eligibility determination application 355, the tracking application 360, the pattern generation application 365, the data processing application 370, the classification application 375, the deviation detection application 380, and the alert generation and transmission application 385 are explained in greater detail in FIGS. 6A and 6B.

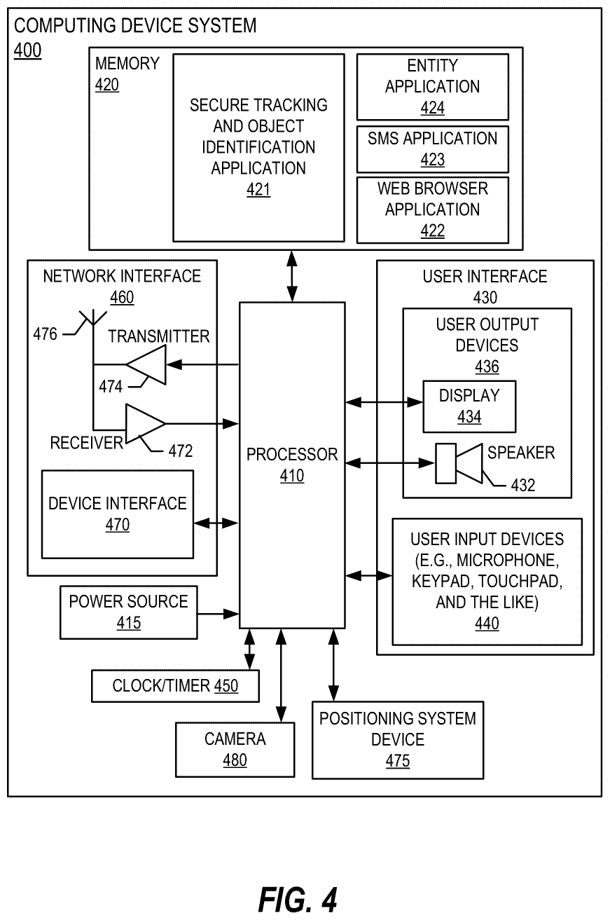

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a secure object tracking and identification application 421, entity application 424, an SMS application 423, or the like. In some embodiments, the entity application 424 may be an online banking application. The secure object tracking and identification application 421 may comprise instructions to a graphical user interface (GUI) on the display 430 that allows the user 110 to interact with the entity system 200, the secure object tracking and identification system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the secure object tracking and identification application 421 provided by the secure object tracking and identification system 300 allows the user 110 to access the secure object tracking and identification system 300. In some embodiments, the entity application 424 provided by the entity system 200 and the secure object tracking and identification application 421 allow the user 110 to access the functionalities provided by the secure object tracking and identification system 300 and the entity system 200. In some embodiments, the entity application 424 may be an online banking application.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

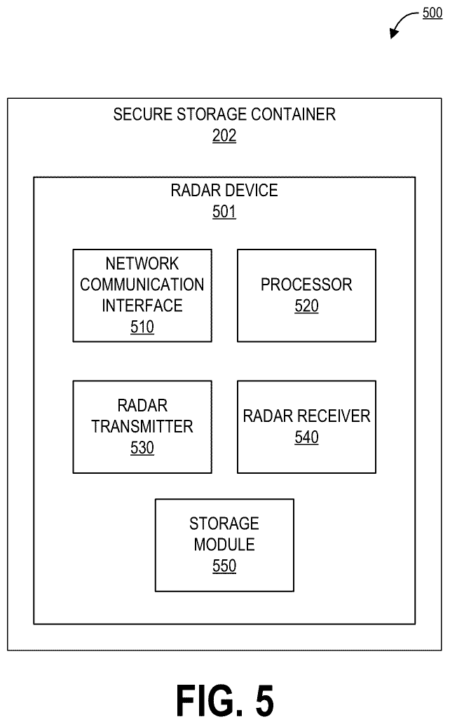

FIG. 5 provides a block diagram 500 illustrating one or more components of a secure storage container 202 of FIG. 1, in accordance with an embodiment of the invention. As shown, the secure storage container 202 comprises a radar device 501 for performing one or more actions described herein. In some embodiments, the radar device 501 may be a chip, where the chip may be a miniature chip. In some embodiments, as shown the radar device 501 may be a part of the secure storage container 202, where the radar device 501 may be placed at any location on the secure storage container 202. In some embodiments, the radar device 501 may be placed on exterior surface of the secure storage container 202. In some embodiments, the radar device 501 may be placed on interior surface of the secure storage container 202. In some embodiments, the radar device 501 may be placed on any of the walls or edges of the secure storage container 202. In some embodiments, the radar device 501 may be external to the secure storage container 202 and not physically connected to the secure storage container 202. In some embodiments, there may ‘n’ number of secure storage containers 202 at an entity location and there may be ‘n’ number of radar devices 501 for each of the ‘n’ number of secure storage containers 202. In some embodiments, there may ‘n’ number of secure storage containers 202 at an entity location and there may be a single radar device for performing the one or more actions on all of the ‘n’ number of secure storage containers 202 at the entity location. In some such embodiments, the single radar device 501 may be placed on any one of the ‘n’ number of secure storage containers 202 or on any of the walls enclosing all of the ‘n’ number of secure storage containers 202 or at any place in the entity location that allows the radar device to perform the one or more actions on the secure storage containers 202.

As shown, the radar device 501 comprises a network communication interface 510, a processor 520, a radar transmitter 530, a radar receiver 540, and a storage module 550. It should be understood that there may be other components of the secure storage container 202 and/or the radar device 501 that are not shown in the figure, where the other components may perform one or more operations described herein. The network communication interface 510 may be responsible for transmitting and receiving all network communications associated with the secure storage container 202. The processor 520 interacts with other components and provides the processing capability to implement/process one or more actions described herein and/or execute one or more instructions received from the secure tracking and object identification system 300. The radar transmitter 530 emits electromagnetic waves (radar waves) onto the one or more objects in the secure storage container 202, where the objects in the path of the electromagnetic waves scatter this energy and reflect some portion back towards the radar device 501. The radar receiver 540 may act as an antenna to capture the reflected waves and calculate one or more parameters associated with the reflected waves (via the processor 520), where the one or more parameters may comprise energy, time delay, time taken for waves to travel back n forth, strength of the wave, frequency shift, and/or the like. The storage module 550 may store one or more data captured, generated, processed, and/or received by the radar device 501. In some embodiments, the one or more components are controlled by the system of the invention to perform one or more steps of the process flows 600A and 600B.

FIG. 6A provides a process flow 600A for eligibility identification of objects in secure storage containers, in accordance with an embodiment of the invention. As shown in block 602, the system detects presence of one or more objects in a secure storage container. The system may continuously monitor the secure storage containers via one or more sensors and/or radar devices associated with the secure storage containers to detect the presence of the one or more objects. In some embodiments, the system may be notified by an entity user and/or user associated with the secure storage containers that one or more objects have been placed in the secure storage container.

As shown in block 605, the system in response to detecting the presence of the one or more objects, causes a radar device to perform one or more actions on the one or more objects in the secure storage container. The one or more actions may comprise transmitting electromagnetic waves onto the one or more objects placed in the secure storage container, in response to transmitting the electromagnetic waves onto the one or more objects, receiving reflected waves back from the one or more objects, and transmitting raw data associated with the reflected waves to the system. The system may transmit one or more instructions to the radar device, where the one or more instructions control one or more components of the radar device to perform the one or more actions.

As shown in block 610, the system receives raw data associated with the one or more actions from the radar device. The raw data may comprise all of the information associated with the reflected waves, where the raw data may comprise information associated with energy, strength, time delay, frequency, time taken for the reflected wave to return to the radar device, and/or the like.

As shown in block 615, the system applies transformations to raw data to generate transformed data. In some embodiments, the system may apply transformations to the raw data to filter out a set of parameters, where the set of parameters may be used for further processing. In some embodiments, the set of parameters may comprise at least strength of the reflected signal, time taken for the reflected wave to travel back to the radar device. In some embodiments, additional parameters may be added to the set of parameters based on requirements of the overall output of the system of the invention.

As shown in block 620, the system processes the transformed data to classify materials associated with the one or more objects in the secure storage container. Classification of the materials may be based on the set of parameters. For example, liquids may have different reflective properties compared to solid materials. Based on the set of parameters, the system may determine a range the set of parameters fall into, where different ranges may be associated with different materials.

As shown in block 625, the system determines eligibility of the materials associated with the one or more objects in the secure storage container based on classification of the materials associated with the one or more objects. The eligibility of materials may be defined by the entity managing and/or maintaining the secure storage containers. For example, the entity may restrict liquids to be placed in the secure storage containers, where liquids have specific reflective properties when hit by radar waves. In another example, the entity may restrict hazardous materials to be placed in the secure storage containers. In some embodiments, the eligibility rules may be modified by the entity at any time. As such, the system determines eligibility of the materials without determining the exact contents of the secure storage container, thereby providing privacy to the users of the secure storage containers.

As shown in block 630, the system determines that at least one object of the one or more objects is not eligible for storage in the secure storage container. Based on the classification of the materials associated with the one or more objects, the system may determine that a material associated with at least one object of the one or more objects is not eligible. As shown in block 635, the system in response to determining that the at least one object of the one or more objects is not eligible, transmits one or more alerts to a user associated with the secure storage container and an entity user associated with an entity managing the secure storage container. In some embodiments, the system may identify that the entity has made changes to the eligibility rules and may repeat the process flow 600A for all of the secure storage containers associated with the entity.

FIG. 6B provides a process flow 600B for secure tracking of objects in secure storage containers, in accordance with an embodiment of the invention. As shown in block 655, the system causes a radar device to perform one or more actions on the one or more objects in the secure storage container. In some embodiments, the system may perform the one or more actions on the one or more objects based on receiving an input from the user to track the one or more objects. In some embodiments, the system may perform the one or more actions continuously. In some embodiments, the system may perform the one or more actions on the one or more objects at predefined intervals, where the predefined intervals may be regular intervals or irregular intervals. As described above, the one or more actions may comprise transmitting electromagnetic waves onto the one or more objects placed in the secure storage container, in response to transmitting the electromagnetic waves onto the one or more objects, receiving reflected waves back from the one or more objects, and transmitting raw data associated with the reflected waves to the system.

As shown in block 660, the system receives raw data from the radar device based on performing the one or more actions. As mentioned above, the raw data may comprise comprise all of the information associated with the reflected waves, where the raw data may comprise information associated with energy, strength, time delay, frequency, time taken for the reflected wave to return to the radar device, and/or the like.

As shown in block 665, the system generates one or more patterns associated with the one or more objects placed in the secure storage container based on the raw data. The system may generate one or more patterns associated with the characteristics of the one or more objects, where the characteristics may be based on the material of the one or more objects determined from the raw data received from the radar device.

As shown in block 670, the system monitors the one or more patterns. As shown in block 675, the system detects a deviation in the one or more patterns. The system may determine that the reflected wave has different values compared to the established patterns and may determine a deviation in the one or more patterns associated with the most recent raw data received by the system from the radar device.

As shown in block 680, the system determines a type of deviation in the one or more patterns. There may be different types of deviations in the one or more patterns, where each of the deviation may define what caused the deviation. For example, displacement of the one or more objects may cause a deviation in the time taken for the reflected waves to travel back to the radar device. In another example, replacement of the material of the one or more objects may cause a deviation in the strength of the reflected waves and/or the time taken for the reflected waves to travel back to the radar device. As shown in block 685, the system determines at least one of displacement of the one or more objects and replacement of the one or more objects in the secure storage container based on the type of deviation. As shown in block 690, the system transmits one or more alerts to a user associated with the secure storage container and an entity user associated with an entity managing the secure storage container.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for secure tracking and eligibility identification of objects in secure storage containers, the system comprising:
a memory device with computer-readable program code stored thereon;
a communication device; and
a processing device operatively coupled to the memory device and the communication device, wherein the processing device is configured to execute the computer-readable program code to:
cause a radar device to perform one or more actions on one or more objects placed in a secure storage container comprising:
transmitting electromagnetic waves onto the one or more objects;
in response to transmitting the electromagnetic waves onto the one or more objects, receiving reflected waves back from the one or more objects; and
transmitting raw data associated with the reflected waves to the system;
receive the raw data associated with the reflected waves from the radar device;
apply transformations to the raw data to generate transformed data;
process the transformed data to classify materials associated with the one or more objects in the secure storage container; and
determine eligibility of the materials associated with the one or more objects in the secure storage container based on classification of the materials associated with the one or more objects.

2. The system according to claim 1, wherein the processing device is further configured to execute the computer-readable program code to:
determine that at least one object of the one or more objects is not eligible for storage in the secure storage container; and
transmit one or more alerts to a user associated with the secure storage container and an entity user associated with an entity managing the secure storage container.

3. The system according to claim 1, wherein the processing device is further configured to execute the computer-readable program code to:
cause the radar device to perform the one or more actions at predefined time intervals;
receive periodic raw data from the radar device based on performing the one or more actions at the predefined time intervals; and
generate one or more patterns associated with the one or more objects placed in the secure storage container based on the periodic raw data.

4. The system according to claim 3, wherein the processing device is further configured to execute the computer-readable program code to:
detect a deviation in the one or more patterns;
determine a type of the deviation in the one or more patterns; and
determine at least one of displacement of the one or more objects and replacement of the one or more objects in the secure storage container based on the type of deviation.

5. The system of claim 4, wherein the processing device is further configured to execute the computer-readable program code to in response to determining at least one of the displacement of the one or more objects and the replacement of the one or more objects in the secure storage container, transmit one or more alerts to a user associated with the secure storage container and an entity user associated with an entity managing the secure storage container.

6. The system according to claim 1, wherein the processing device is further configured to execute the computer-readable program code to:
cause the radar device to perform the one or more actions continuously;
receive continuous raw data from the radar device based on performing the one or more actions continuously;
generate one or more patterns associated with the one or more objects placed in the secure storage container based on the continuous raw data; and
continuously monitor the one or more patterns for deviation.

7. The system according to claim 1, wherein the processing device is further configured to execute the computer-readable program code to:
receive an input associated with tracking of the one or more objects placed in the secure storage container form a user associated with the secure storage container;
cause the radar device to perform the one or more actions based on receiving the input;
receive on-demand raw data from the radar device;
process the on-demand raw data and provide an output to the user associated with the tracking of the one or more objects in the secure storage container.

8. A computer program product for secure tracking and eligibility identification of objects in secure storage containers, the computer program product comprising at least one non-transitory computer readable medium having computer-readable program code portions embodied therein, the computer-readable program code portions comprising executable portions for:
causing a radar device to perform one or more actions on one or more objects placed in a secure storage container comprising:
transmitting electromagnetic waves onto the one or more objects;
in response to transmitting the electromagnetic waves onto the one or more objects, receiving reflected waves back from the one or more objects; and
transmitting raw data associated with the reflected waves;
receiving the raw data associated with the reflected waves from the radar device;
applying transformations to the raw data to generate transformed data;
processing the transformed data to classify materials associated with the one or more objects in the secure storage container; and
determining eligibility of the materials associated with the one or more objects in the secure storage container based on classification of the materials associated with the one or more objects.

9. The computer program product of claim 8, wherein the computer-readable program code portions comprising executable portions for
determining that at least one object of the one or more objects is not eligible for storage in the secure storage container; and
transmitting one or more alerts to a user associated with the secure storage container and an entity user associated with an entity managing the secure storage container.

10. The computer program product of claim 9, wherein the computer-readable program code portions comprising executable portions for:
causing the radar device to perform the one or more actions at predefined time intervals;
receiving periodic raw data from the radar device based on performing the one or more actions at the predefined time intervals; and
generating one or more patterns associated with the one or more objects placed in the secure storage container based on the periodic raw data.

11. The computer program product of claim 10, wherein the computer-readable program code portions comprising executable portions for:
detecting a deviation in the one or more patterns;
determining a type of the deviation in the one or more patterns; and
determining at least one of displacement of the one or more objects and replacement of the one or more objects in the secure storage container based on the type of deviation.

12. The computer program product of claim 11, wherein the computer-readable program code portions comprising executable portions for in response to determining at least one of the displacement of the one or more objects and the replacement of the one or more objects in the secure storage container, transmitting one or more alerts to a user associated with the secure storage container and an entity user associated with an entity managing the secure storage container.

13. The computer program product of claim 8, wherein the computer-readable program code portions comprising executable portions for:
causing the radar device to perform the one or more actions continuously;
receiving continuous raw data from the radar device based on performing the one or more actions continuously;
generating one or more patterns associated with the one or more objects placed in the secure storage container based on the continuous raw data; and
continuously monitoring the one or more patterns for deviation.

14. A computer-implemented method for secure tracking and eligibility identification of objects in secure storage containers, the method comprising:
causing a radar device to perform one or more actions on one or more objects placed in a secure storage container comprising:
transmitting electromagnetic waves onto the one or more objects;
in response to transmitting the electromagnetic waves onto the one or more objects, receiving reflected waves back from the one or more objects; and
transmitting raw data associated with the reflected waves;
receiving the raw data associated with the reflected waves from the radar device;
applying transformations to the raw data to generate transformed data;
processing the transformed data to classify materials associated with the one or more objects in the secure storage container; and
determining eligibility of the materials associated with the one or more objects in the secure storage container based on classification of the materials associated with the one or more objects.

15. The computer-implemented method of claim 14, wherein the method comprises:
determining that at least one object of the one or more objects is not eligible for storage in the secure storage container; and
transmitting one or more alerts to a user associated with the secure storage container and an entity user associated with an entity managing the secure storage container.

16. The computer-implemented method of claim 15, wherein the method further comprises:
causing the radar device to perform the one or more actions at predefined time intervals;
receiving periodic raw data from the radar device based on performing the one or more actions at the predefined time intervals; and
generating one or more patterns associated with the one or more objects placed in the secure storage container based on the periodic raw data.

17. The computer-implemented method of claim 16, wherein the method comprises:
detecting a deviation in the one or more patterns;
determining a type of the deviation in the one or more patterns; and
determining at least one of displacement of the one or more objects and replacement of the one or more objects in the secure storage container based on the type of deviation.

18. The computer-implemented method of claim 17, wherein the method comprises in response to determining at least one of the displacement of the one or more objects and the replacement of the one or more objects in the secure storage container, transmitting one or more alerts to a user associated with the secure storage container and an entity user associated with an entity managing the secure storage container.

19. The computer-implemented method of claim 14, wherein the method comprises:
causing the radar device to perform the one or more actions continuously;
receiving continuous raw data from the radar device based on performing the one or more actions continuously;
generating one or more patterns associated with the one or more objects placed in the secure storage container based on the continuous raw data; and
continuously monitoring the one or more patterns for deviation.

20. The computer-implemented method of claim 14, wherein the method comprises:
receiving an input associated with tracking of the one or more objects placed in the secure storage container form a user associated with the secure storage container;
causing the radar device to perform the one or more actions based on receiving the input;
receiving on-demand raw data from the radar device;
processing the on-demand raw data and provide an output to the user associated with the tracking of the one or more objects in the secure storage container.
